(19) United States
(12) Patent Application Publication
(10) Pub. No.: US 2006/0077053 A1
(43) Pub. Date: Apr. 13, 2006

(54) Method of operating an emergency information and/or security system thereof

(75) Inventors: Kyun-hoe Park, Suwon-si (KR); Kyoung-won Kim, Yongin-si (KR); Woon-geun Kwak, Seongnam-si (KR); Sang-jin Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/239,066

(22) Filed: Sep. 30, 2005

(30) Foreign Application Priority Data
Oct. 1, 2004 (KR) 10-2004-007835

(51) Int. Cl. G08B 19/00; H04M 11/04; G08B 1/00

(52) U.S. Cl. 340/521; 340/531; 455/404.1

(57) ABSTRACT

The present invention relates to a security system comprising a message sending server to send a message to a user terminal having an identifier (a phone number or an e-mail address); at least one sensor to sense whether an emergency arises; and a controller that previously registers location information of each sensor therein, accesses the message sending server through Internet, and sends the identifier of the user terminal, the location information of the sensor, and emergency information to the message sending server to transmit the location information and the emergency information as the message to the user terminal when the sensor senses that the emergency arises. Thus the present invention provides a security system letting a user to know not only whether an emergency arises but also where the emergency arises.

### CROSS-REFERENCE TO RELATED APPLICATION

This application claims the benefit of Korean Patent Application No. 10-2004-0078375, filed on Oct. 1, 2004, in the Korean Intellectual Property Office, the disclosure of which is incorporated herein by reference.

### BACKGROUND OF THE INVENTION

1. Field of the Invention

The present invention relates to a security system, and more particularly, to a security system letting a user to know not only whether an emergency arises but also where the emergency arises

2. Description of the Related Art

FIG. 1 is a block diagram of a conventional security system.

As shown in FIG. 1, a conventional security system includes a plurality of sensors 10 to sense whether an emergency arises, and a sensed information receiver 12 to receive sensed information from the sensor 10 and to transmit it to a user terminal 16 through a public switched telephone network (PSTN) 14.

The sensor 10 senses whether a predetermined emergency arises, and transmits the sensed information to the sensed information receiver 12.

The sensed information receiver 12 analyzes the sensed information received from the sensor 10, and informs a user of the emergency by a voice through the PSTN 14.

However, because the conventional security system employs the PSTN 14, a means for informing a user of the emergency is limited to the voice.

Further, it is impossible to inform a user of where the emergency arises based on location of the sensor 10. For example, the sensor 10 installed in a main room window senses that the emergency arises, the conventional security system informs a user of only the emergency without informing where the sensor 10 is located.

Also, the emergency is not recorded. Therefore, if a user does not receive information about the emergency while a user terminal is disabled, a user cannot know when and where emergency arises any more.

### SUMMARY OF THE INVENTION

Additional aspects and/or advantages of the invention will be set forth in part in the description which follows and, in part, will be obvious from the description, or may be learned by practice of the invention.

Accordingly, it is an aspect of the present invention to provide a security system letting a user to know not only whether an emergency arises but also where the emergency arises.

The foregoing and/or other aspects of the present invention are also achieved by providing a security system comprising a message sending server to send a message to a user terminal having an identifier (a phone number or an e-mail address); at least one sensor to sense whether an emergency arises; and a controller that previously registers location information of each sensor therein, accesses the message sending server through Internet, and sends the identifier of the user terminal, the location information of the sensor, and emergency information to the message sending server to transmit the location information and the emergency information as the message to the user terminal when the sensor senses that the emergency arises.

According to an aspect of the present invention, the controller includes a sensed information receiving control card comprising a sensed information receiving module to receive sensed information from the sensor; a home server accessing the message sending server through the Internet and sending the identifier (a phone number or an e-mail address) of the user terminal, the location information, and the emergency information to the message sending server when determines that the emergency arises on the basis of the sensed information received by the sensed information receiving control card; and a wakeup module provided in the sensed information receiving control card, and waking up the home server when determines that the emergency arises on the basis of the sensed information received by the sensed information receiving module.

According to an aspect of the present invention, the home server includes a sensor application that previously registers the location information of each sensor to the sensed information receiving control card; is automatically executed while the home server is waked up; reads out the emergency information and the location information of the sensor sensing the emergency from the sensed information receiving control card; sends the emergency information, the location information of the sensor, and the identifier of the user terminal to the message sending server; and records the emergency information and the location information of the sensor that senses the emergency.

According to an aspect of the present invention, the security system further includes at least one camera to photograph the emergency; wherein the sensor application captures the photographed emergency, and transmits the captured image to the message sending server or storing the captured image in the home server when the camera photographs the emergency.

According to an aspect of the present invention, the home server includes a camera application that controls the camera to map the location information of each sensor; and controls the camera to move tracking along the corresponding location information of the sensor and to photograph the emergency when the sensor senses that the emergency arises by interlocking with the sensor application.

According to an aspect of the present invention, the home server includes an IP register application that access the message sending server through the Internet and sends IP information itself and the identifier (a phone number or an e-mail address) of the user terminal to the message sending server to transmit the message to the user terminal or to transmit the message to E-mail address of a user.

According to an aspect of the present invention, a security system includes a message sending server to send a message to a user terminal having an identifier; at least one sensor to sense whether an emergency arises; and a controller having a location information of each sensor therein, accesses the message sending server, and sends the location information of the sensor, and an emergency information to the message sending server to transmit the location information and the emergency information as a message to the user terminal when the sensor senses that the emergency arises.

According to an aspect of the present invention, the controller includes an information receiving control part to receive the emergency information from the sensor; and a home server accessing the message sending server and sending the identifier of the user terminal, the location information, and the emergency information to the message sending server when determines that the emergency arises based on the emergency information.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a block diagram of a conventional security system;

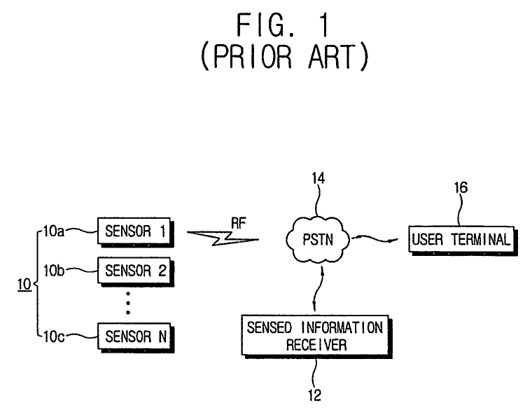

FIG. 2 is a block diagram of a security system according to an embodiment of the present invention;

FIG. 3 is a block diagram of a sensed information receiving control card according to an embodiment of the present invention;

FIG. 4 is a block diagram illustrating connection between the sensed information receiving control card and a home server according to an embodiment of the present invention;

FIG. 5 illustrates operation recording of a sensor and a camera by way of example;

FIG. 6 is a control flowchart of the security system according to an embodiment of the present invention to prepare for emergency;

FIG. 7 is a control flowchart of a sensor application of FIG. 6; and

FIG. 8 is a control flowchart of interlocking between the sensor application of FIG. 6 and a camera application.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

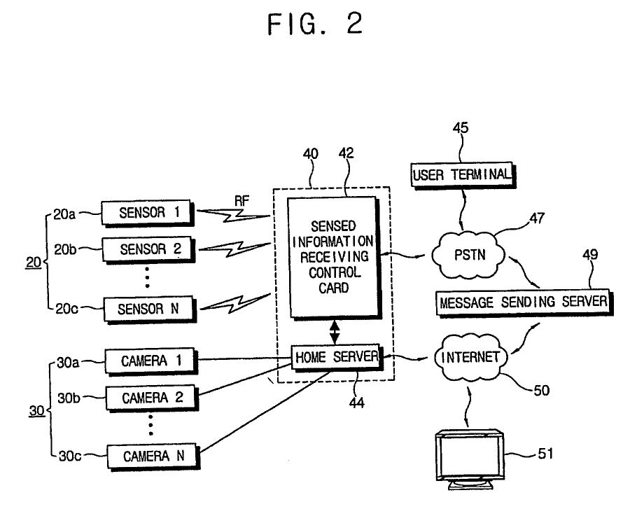

FIG. 2 is a block diagram of a security system according to an embodiment of the present invention. As shown therein, a security system according to an embodiment of the present invention includes at least one sensor 20, and/or at least one camera 30, a controller 40 being accessible to a telephone network (e.g., PSTN) 47 and/or the Internet 50 and including a sensed information receiving control card 42 and a home server 44, a message sending server 49 to send a message to a user terminal 45 having an identifier (a phone number or e-mail address) through the telephone network 47 and to communicate with the home server 44 through the Internet 50.

The sensor 20 senses whether a predetermined emergency arises, and transmits sensed information as a radio frequency (RF) signal to the sensed information receiving control card 42. It is also understood that the sensed information may transmitted by a telephone network or LAN (Local Area Network) etc. Here, the emergency indicates occurrence that happens unexpectedly, for example, door opening due to housebreaking, human motion, window breaking, or the like. The sensor 20 includes a magnetic sensor, an impact sensor, an infrared sensor a thermo sensor, gas sensor, touch sensor, etc, thereby sensing opening/closing of a window, impact on the window, the window breaking, the human motion, or the like.

The camera 30 automatically moves along motion of an object. According to an aspect of the present invention, the camera is connected to a predetermined port (e.g., universal serial bus (USB) port) of the home server 44, and controlled by the home server 44.

The sensed information receiving control card 42 is connected to a mother board of the home server 44, and driven by power from the mother board. Further, the sensed information receiving control card 42 receives the sensed information from the sensor 20, and transmits it to the home server 44. Alternatively, the sensed information receiving control card 42 may receive the power from not the mother board of the home server 44 but a battery to be mounted thereto.

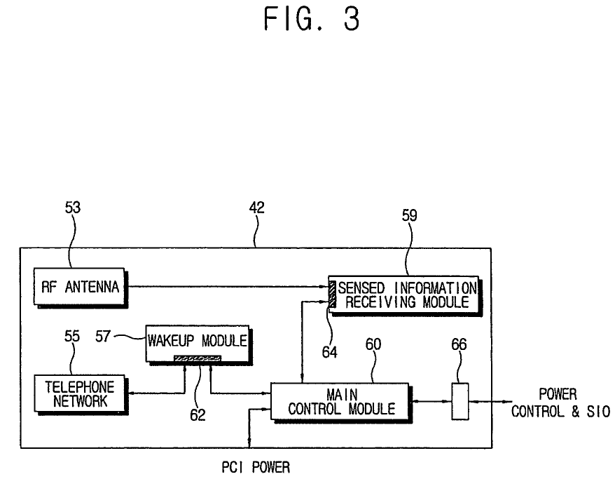

As shown in FIG. 3, the sensed information receiving control card 42 includes an RF antenna 53 to receive the sensed information from the sensor 20; a sensed information receiving module 59 to receive the sensed information from the sensor 20 and communicate the information with a main control module 60; a telephone network connection part 55 to access the telephone network 47; a wakeup module 57 to wake up the home server 44; and the main control module 60 to control the sensed information receiving module 59 and the wakeup module 57. Further, the sensed information receiving control card 42 includes a storage (not shown) to store a list of the sensors 20 currently registered in the card 42, and information about location of each sensor 20 (e.g., first sensor—main room window)

The sensed information receiving control card 42 can be realized by a peripheral component interface (PCI) board having connectors 64, 62 to which the sensed information receiving module 59 and the wakeup module 57 are connected. Further, the sensed information receiving control card 42 is connected to a PCI slot provided in the home server 44, and connected to the mother board of the home server 44 through a separate connector 66. However, the sensed information receiving control card 42 is not limited to the PCI board, and may be realized by a board having other interface.

The telephone network connection part 55 may include an RJ-11 jack to receive a ring signal or a dual tone multi frequency (DTMF) tone transmitted from the external user terminal 45 to the telephone network 47 according to an aspect of the present invention.

The wakeup module 57 generates a wakeup signal in response to the ring signal received through the telephone network connection part 55, or in response to control of the main control module 60.

The main control module 60 processes data inputted from the sensed information receiving module 59 and the wakeup module 57, and communicates with the home server 44 through the connector 66. The main control module 60 communicates the information with the sensed information receiving module 59 and determines whether the emergency arises. When it is determined that the emergency arises, the main control module 60 controls the wakeup module 57 to generate and output the wakeup signal to the home server 44 through the connector 66, thereby waking up the home server 44.

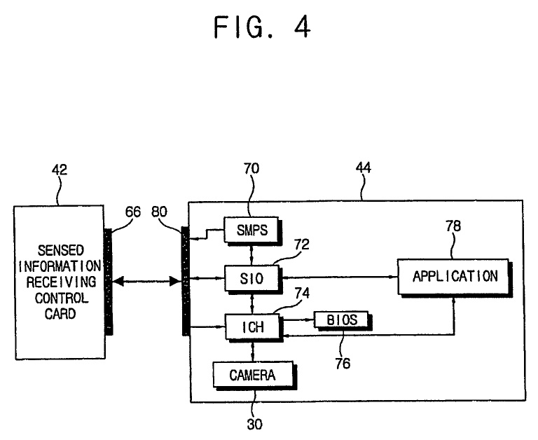

FIG. 4 is a block diagram illustrating connection between the sensed information receiving control card and a home server according to an embodiment of the present invention. As shown in FIG. 4, the sensed information receiving control card 42 and the home server 44 includes the connectors 66 and 80 to be connected each other, respectively.

The home server 44 includes a switching mode power supply (SMPS) 70 to supply the power; a serial input/output (SIO) 72 to communicate a serial data signal with the sensed information receiving control card 42; an I/O controller hub (ICH) 74 to control input/output of data; the camera 30 connected to the ICH 74; a basic input/output system (BIOS) 76; and an application 78 to control the sensed information receiving control card 42, the camera 30, or the like by communicating with the SIO 72 and the ICH 74. It is understood that the home server 44 also may include HDD (Hard Disk Driver) or memories to store sensed information.

The SIO 72, the ICH 74 and the SMPS 70 of the home server 44 are connected to the sensed information receiving control card 42 through the connectors 66, 80.

The SMPS 70 of the home server 44 supplies the power to the sensed information receiving control card 42 through the connector 80, thereby driving the sensed information receiving control card 42.

The SIO 72 outputs a power-on signal to the SMPS 70 in response to the wakeup signal received from the wakeup module 57 of the sensed information receiving control card 42, thereby allowing the SMPS 70 to supply the power to the home server 44.

Here, when the power is supplied to the home server 44, if the BIOS 76 has a password, booting is not implemented while waking up the home server 44. Therefore, according to an embodiment of the present invention, a general purpose input/output (GPIO) port of the ICH 74 is connected to the main control module 60 of the sensed information receiving control card 42. Further, while the wakeup signal is transmitted to the home server 44, the main control module 60 is programmed to control the GPIO port of the ICH 74 and to make the BIOS 76 skip over checking the password.

Further, the SIO 72 transmits power state information of the home server 44 to the sensed information receiving control card 42. Thus, in the security system according to an embodiment of the present invention, when the power of the home server 44 is controlled in response to the ring signal or according as the emergency is sensed by the sensor 20, a voice message about a power state of the home server 44 is transmitted through the user terminal 45. Here, the user terminal 45 for the voice message includes a wire terminal and/or a wireless terminal.

For example, the main control module 60 determines the power state of the home server 44 to check whether the home server 44 is normally waked up. When the home server 44 is turned on, the main control module 60 sends a voice message of “the home server is turned on” to the user terminal 45 through the telephone network connection part 55. On the other hand, when the home server 44 is not turned on, the main control module 60 makes a beeping sound for a few seconds and then sends a voice message of “failed” to the user terminal 45 through the telephone network connection part 55. Likewise, the main control module 60 operates in the same manner when the power of the home server 44 is controlled by the DTMF tone.

Further, the sensed information receiving control card 42 and the home server 44 may communicate the sensed information and state/control information with each other through an RS-232C interface of the SIO 72 according to an aspect of the invention.

Also, the GPIO port of the ICH 74 is designated as a port to sense whether the sensed information receiving control card 42 is connected to the home server 44, and thus the BIOS 76 enables the RS-232C interface of the SIO 72 only when it is sensed that the sensed information receiving control card 42 is connected to the home server 44.

The application 78 programmed in the home server 44 includes a sensor application to control the sensed information receiving control card 42, a camera application to control the camera 30, and an Internet protocol (IP) register application.

The sensor application is programmed to be automatically executed while the home server 44 is waked up. When the sensor application is executed, the sensor application reads the emergency sensed information from the sensed information receiving control card 42 and is connected to the message sending server 49 through the internet 50. Here, the emergency sensed information contains the list of the sensors 20 that senses the emergency, and location information thereof, and emergency information. The sensor application accesses the message sending server 49 and sends the emergency sensed information and the phone number of the user terminal 45 to the message sending server 49, thereby sending sensed information data as a character to the user terminal 45. This allows a user to directly know where the sensor 20 sensing the emergency is located when the user receives the character/or image message. In this case, the user terminal 45 is capable of receiving the character/or image message.

The camera application is programmed to interlock with the sensor application or maybe programmed to operate independently. Here, interlocking between the camera application and the sensor application can be accomplished by storing the location information of each sensor 20 through the camera application. Here, when the camera 30 is relocated, the location information of the each sensor 20 should be renewed.

The sensor application can request the camera application to control the camera 30 to record a scene when the sensor application receives the emergency sensed information from the sensed information receiving control card 42. At this time, the camera application receives the location information of the sensor 20 that senses the emergency from the sensor application, and moves the camera 30 to the location of the sensor 20, thereby starting recording the scene. It is understood that a user may request the camera 30 application to control the camera 30 to record the scene.

The camera 30 moves tracking a motion when senses the motion, but otherwise moves patrolling.

When recording the scene is completed, the camera application access the message sending server 49 and sends a photographed still picture or a moving picture together with the phone number of the user terminal 45 to the message sending server 49, thereby transmitting the photographed still image or the moving picture to the user terminal 45. Here, the picture photographed by the camera 30 can be stored in a disk of the home server 44. Therefore, the emergency sensed information is stored even though the Internet 50 is disabled, so that it is possible to check whether the emergency arises or not by retrieving local record information stored in the local disk.

Alternatively, the camera application can control the camera 30 to operate independently of the sensor application.

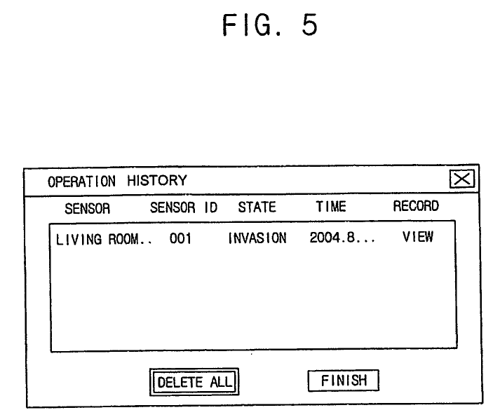

The IP register application reads out IP information from the home server 44 when the home server 44 is waked up, and sends the IP information to the message sending server 49, thereby transmitting a message about the IP information to the user terminal 45 or transmitting the IP information to an E-mail address of a user. Thus, a user can access the home server 44 through an external personal computer 51 or personal digital assistants on the basis of the IP information, thereby inquiring of the camera application about operation history of the sensor 20 and/or the camera 30 (refer to FIG. 5) or controlling the camera 30 to operate.

FIG. 5 illustrates an operation history of a sensor and a camera by way of example according to an aspect of the present invention. As shown in FIG. 5, the operation history of the sensor 20 and the camera 30 shows a user a sensor name containing the location information of the sensor 20, whether and when the emergency arises, whether the recorded scene exists, and so on. Thus, the information on the emergency can be recorded so as to manage it.

The message sending server 49 sends a message based on the data transmitted from the home server 44 as at least one type of a character, a still picture, and a moving picture to the user terminal 45 through the telephone network 47, wireless LAN or other networks.

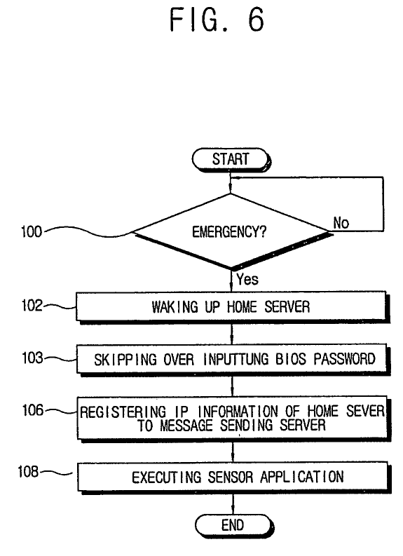

FIG. 6 is a control flowchart of waking up the home server 44 in the security system according to an embodiment of the present invention.

First, at operation 100, when the main control module 60 determines that emergency arises on the basis of the sensed information of the sensor 20 received from the sensed information receiving module 59, the main control module 60 controls the wakeup module 57 to generate the wakeup signal. Here, the wakeup signal is outputted from the wakeup module 57 to the home server 44 through the connector 66. The wakeup signal functions as a power-on signal. At operation 102, the home server 44 is turned on. At operation 103, the main control module 60 controls the GPIP port of the ICH 74 provided in the home server 44, thereby making the BIOS 76 skip over checking the password. Then, booting is implemented and an operating system is running, thereby executing the IP register application of the home server 44. As the IP register application is executed, at operation 106, the IP information of the home server 44 is registered to the message sending server 49, thereby transmitting a message about the IP information of the home server 44 to the user terminal 45. Then, at operation 108, the sensor application for controlling the sensed information receiving control card 42 is executed.

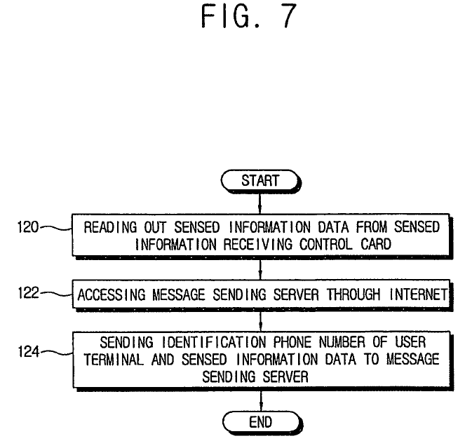

As the sensor application is executed, as shown in FIG. 7, at operation 120, the sensor application reads out the emergency sensed information data from the sensed information receiving control card 42. Then, at operation 122, the sensor application accesses the message sending server 49 through the Internet 50. Then, at operation 124, the sensor application sends the phone number of the user terminal 45 and the emergency sensed information data to the message sending server 49, thereby allowing the message sending server 49 to send the emergency sensed information as a character type to the user terminal 45. At this time, the sensed information transmitted to the user terminal 45 includes information about where the emergency is sensed. Thus, it is possible to let a user know which sensor 20 senses the emergency, that is, where the emergency arises.

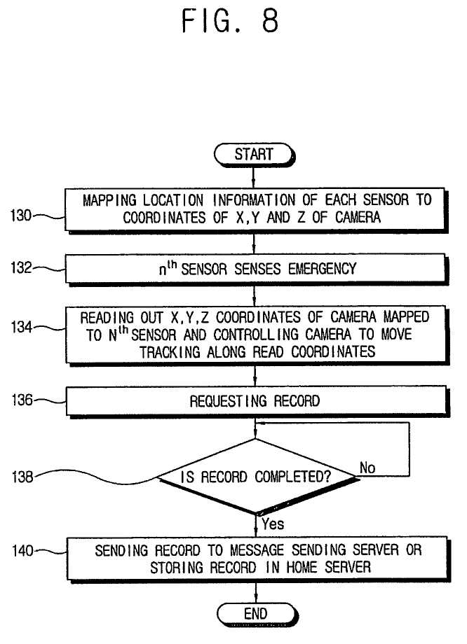

FIG. 8 is a control flowchart of interlocking between the sensor application and the camera application.

As shown in FIG. 8, at operation 130, the camera application controls the camera 30 to map location information of each sensor 20 into coordinates of X, Y and Z. When the sensor application senses the emergency at operation 132, at operation 134, the camera application reads out the X, Y, Z coordinates of the camera 30 corresponding to the sensor 20 sensing the emergency and controls the camera 30 to moves tracking toward the corresponding coordinates. At operation 136, the sensor application requires the camera application to record the scene. When the camera application completes recording the scene at operation 138, at operation 140, the camera application sends the recorded scene with the phone number of the user terminal 45 to the message sending server 49, thereby transmitting a visual message to the user terminal 45 or storing the recorded scene in the local disk of the home server 44.

According to an embodiment of the present invention, a remote controller (not shown) may be added to register the sensor 20 to the sensed information receiving control card 42. Further, the message sending server 49 may access a security business server through the Internet 50, thereby informing a user of the emergency.

As described above, the present invention provides a security system letting a user to know not only whether an emergency arises but also where the emergency arises.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A security system comprising:
a message sending server to send a message to a user terminal having an identifier;
at least one sensor to sense whether an emergency arises; and
a controller having a location information of each sensor therein, accesses the message sending server, and sends the location information of the sensor, and an emergency information to the message sending server to transmit the location information and the emergency information as a message to the user terminal when the sensor senses that the emergency arises.

2. The security system according to claim 1, wherein the controller comprises:
an information receiving control part to receive the emergency information from the sensor; and
a home server accessing the message sending server and sending the identifier of the user terminal, the location information, and the emergency information to the message sending server when determines that the emergency arises based on the emergency information.

3. The security system according to claim 2, wherein the home server comprises a sensor application is automatically executed while the home server is waked up; reads out the emergency information and the location information of the sensor sensing the emergency from the information receiving control part; sends the emergency information, the location information of the sensor, and the identifier of the user terminal to the message sending server; and records the emergency information and the location information of the sensor that senses the emergency.

4. The security system according to claim 1, further comprising at least one camera to photograph the emergency;
wherein the sensor application captures the photographed emergency, and transmits the captured image to the message sending server or storing the captured image in the home server when the camera photographs the emergency.

5. The security system according to claim 4, wherein the home server comprises a camera application that controls the camera to map the location information of each sensor; and controls the camera to move tracking along the corresponding location information of the sensor and to photograph the emergency when the sensor senses that the emergency arises by interlocking with the sensor application.

6. The security system according to claim 3, wherein the home server comprises an IP register application that access the message sending server through an Internet or a telephone network and sends IP information itself and the identifier of the user terminal to the message sending server to transmit the message to the user terminal or to transmit the message to E-mail address of a user.

7. The security system according to claim 4, wherein the home server comprises an IP register application that access the message sending server through the Internet and sends IP information itself and the identifier of the user terminal to the message sending server to transmit the message to the user terminal or to transmit the message to E-mail address of a user.

8. The security system according to claim 2, the controller further comprising:
a wakeup module provided in the information receiving control part, and waking up the home server when determines that the emergency arises based on the sensed information received by the sensed information receiving module.

9. The security system according to claim 6, the identifier is anyone of a phone number or e-mail address of the user terminal.

10. The security system according to claim 1, wherein the message further comprising:
a time information indicating when the emergency arises.

11. The security system according to claim 1, wherein the message further comprising:
a status of the emergency.

12. The security system according to claim 1, wherein the identifier is any one of a phone number and an e-mail address.

13. A method of operating emergency information, the method comprising:
storing a location information;
sensing an emergency information; and
creating an emergency message in accordance with the location information and the emergency information.

14. The method according to claim 13, further comprising:
storing the emergency message in a recording medium.

15. The method according to claim 13, further comprising:
storing an identifier.

16. The method according to claim 15, further comprising:
sending the emergency message to a user using the identifier.

17. The method according to claim 15, wherein the identifier is any one of a phone number, and an e-mail address.

18. The method according to claim 16, wherein the emergency message comprises any one of a character, and an image.

19. The method according to claim 15, wherein the emergency message comprises any one of sensor information, time information, and status information.

20. The method according to claim 13, wherein the emergency information is from any one of a sensor, and a camera.

21. The method according to claim 14, wherein the recording medium is any one of a HDD disc, a DVD disc, and is remotely located.
